(19) United States
(12) Patent Application Publication
(10) Pub. No.: US 2009/0328167 A1
(43) Pub. Date: Dec. 31, 2009

(54) NETWORK ACCESS METHOD AND SYSTEM

(76) Inventor: Donal O'Mahony, County Dublin (IE)

Correspondence Address: JACOBSON HOLMAN PLLC, 400 SEVENTH STREET N.W., SUITE 600, WASHINGTON, DC, 20004, US

(21) Appl. No.: 12/309,857

(22) PCT Filed: Aug. 1, 2007
(86) PCT No.: PCT/IE2007/000075

§ 371 Date: Feb. 2, 2009

Related U.S. Application Data
(60) Provisional application No. 60/835,084, filed on Aug. 3, 2006.

(51) Int. Cl. H04L 29/06

(52) U.S. Cl. 726/6; 713/185; 726/9

(57) ABSTRACT

A method for controlling access to a communication network such as a Wi-Fi network includes a user device (1) transmitting a network access request including an access token in at least one field of an authentication exchange. An access control server (4) determines a network access credit corresponding to the token, and allows access by the user device (1) to the network in real time to the extent of the credit. The authentication fields may be username and password fields under the RADIUS protocol. A network access server (2) processes the authentication field without recognising that it contains a token. It passes the network access request to a RADIUS authentication server (3), which in turn routes it to the access control server (4) again without recognising that the authentication fields include tokens. The invention therefore achieves real time network access without need for modification of network access servers or authentication servers.

### FIELD OF THE INVENTION

The invention relates to set-up and maintenance of communication sessions. The invention applies to any type of network which involves communication, including ones which charge for communication in the traditional sense only such as voice or messaging, and ones which charge for information or products accessed or downloaded.

### PRIOR ART DISCUSSION

The Remote Authentication Dial In User Service (RADIUS) is the most widely deployed Authentication, Authorization and Accounting (AAA) protocol for applications such as network access or IP mobility, and is intended to work in both local and roaming situations [RWRS00, AAA].

When a user connects to an Internet Service Provider (ISP) using a modem, DSL, cable or wireless connection, he is usually prompted for a username and password. This information is passed to a Network Access Server (NAS) also known as a RADIUS client, then to a RADIUS server using the RADIUS signalling protocol. The RADIUS server checks that the information is correct using authentication schemes like the Password Authentication Protocol (PAP). All communications between a RADIUS client and server are authenticated through the use of a shared secret. User passwords are sent encrypted between the client and the RADIUS server. If accepted, the server will then authorize access to the ISP system.

The RADIUS server will also be notified if and when the session starts and stops, so that the user can be billed accordingly; or the data can be used for statistical purposes. The NAS forwards an Accounting-Start message to the RADIUS server describing the type of service being delivered and the user to whom it is being delivered. The client collects information about the session, the number of input and output octets and the session duration. At the end of the service delivery the client will generate an Accounting-Stop message and sends it to the server. In each case an acknowledgement is sent back by the server.

Thus, accounting in the majority of wired and wireless networks consists of a call detail record (CDR) generated by the ISP's RADIUS server based on which the end user is billed. The user has no real way of knowing whether or not he has been billed for the correct amount. He is totally reliant on the ISP to generate the correct accounting data.

[Peirce & O'Mahony] and [Tewari & O'Mahony] both describe micropayment mechanisms involving use of hashes as payment tokens. However, implementation of such mechanisms involves a requirement for comprehensive programming of the various servers involved in network access control.

The invention is therefore directed towards providing a mechanism for network access which avoids the prior billing schemes and does not require modification of existing network access servers.

### REFERENCES

[AAA] Authentication, Authorization and Accounting (AAA) Working Group Charter, http://www.ietf.org/html.charters/aaa-charter.html.

[HSW96] R. Hauser, M. Steiner, and M. Waidner, “Micro-payments Based on iKP”, Proceedings of the 14^{th} Worldwide Congress on Computer and Communications Security Protection, Paris, 1996, pp. 67-82.

[Lam81] L. Lamport, “Password Authentication with Insecure Communication”, Communications of the ACM, vol. 24, no. 11, November 1981, pp. 770-772.

[RS96] R. Rivest and A. Shamir, “PayWord and MicroMint: Two Simple Micropayment Schemes”, Proceedings of the 4th Security Protocols International Workshop (Security Protocols), LCNS, vol. 1189, Berlin: Spriger-Verlag, 1996, pp. 69-87.

[RWRS00] C. Rigney, S. Willens, A. Ruben and W. Simpson, “Remote Authentication Dial In User Service”, IETF RFC 2865, June 2000.

[WiFi] Wi-Fi Alliance, http://www.wi-fi.org/

[Peirce & O'Mahony] M. Peirce & D. O'Mahony, “Flexible Real-Time Payment Methods for Mobile Communications”, IEEE Personal Communications, December 1999, 1070-9916/99/, pp 44-55.

[Tewari & O'Mahony] H. Tewari & D. O'Mahony, “Real-Time Payments for Mobile IP”, IEEE Communications Magazine, February 2003, 0163-6804/031, pp 126-136.

### SUMMARY OF THE INVENTION

According to the invention, there is provided a method for controlling access to a communication network, the method comprising the steps of:
(a) a user device transmitting a network access request including an access token in at least one field of an authentication exchange, and
(b) an access control server determining a network access credit corresponding to the token, and allowing access by the user device to the network in real time to the extent of the credit.

In one embodiment, the method comprises the additional steps of repeating steps (a) and (b) for incrementally adding to a single communication session.

In another embodiment, the credit is a time period, and steps (a) and (b) are repeated to add at least one time period to the session.

In a further embodiment, an authentication field is a username field.

In one embodiment, an authentication field is a password field.

In another embodiment, the authentication field is under the RADIUS protocol.

In a further embodiment, a network access server processes the authentication field without recognising that it contains a token.

In one embodiment, the network access server passes the request to an authentication server.

In another embodiment, said authentication server is a proxy server.

In a further embodiment, the authentication server processes the access token without recognising that the content of the authentication field is a token.

In one embodiment, the authentication server communicates with the access control server for access token validation.

In another embodiment, the access token is encrypted.

In a further embodiment, the access token includes a hash value.

In one embodiment, the user device stores a chain of hash values, and releases a hash value from a hash chain as a token, and successive access tokens include successive hash values.

In another embodiment, the access token also includes a hash chain identifier.

In a further embodiment, the encryption provides alphanumeric characters for the token.

In one embodiment, the encrypted token is split across a plurality of authentication fields.

In another embodiment, a token includes a flag, recognised by the authentication server, indicating that the access control server needs to process it.

In a further embodiment, the flag is a HTTP domain name.

In one embodiment, the method comprises the further steps of the user device initially accessing a token-selling server which manages token issuing.

In another embodiment, the user device generates the tokens and updates the token-selling server.

In a further embodiment, the user device uploads the tokens to the token-selling server, the server registers them in a database, and transmits a receipt to the user device.

In one embodiment, the token-selling server generates a message or ticket with the token, sends the message or ticket to the user, and the user manually inputs the token in the authentication field for network access.

In another aspect, there is provided a communication system comprising a user device and an access control server for performing the steps of any method define above.

In a further aspect, there is provided a computer readable medium comprising software code for performing user device steps of any method defined above when executing on a user device processor.

In one embodiment the medium comprises software code for performing server steps of any method defined above when executing on a server processor.

### DETAILED DESCRIPTION OF THE INVENTION

### Brief Description of the Drawings

The invention will be more clearly understood from the following description of some embodiments thereof, given by way of example only with reference to the accompanying drawings in which:

FIG. 1 is a diagram illustrating the generation of tokens for network access by a user device;

FIG. 2 is a diagram illustrating an alternative process for generating tokens;

FIG. 3 illustrates how the tokens are inserted in authentication exchange fields by the user device; and

FIG. 4 illustrates operation of systems involved in spending of the tokens for network access.

### DESCRIPTION OF THE EMBODIMENTS

The invention provides a mechanism for managing communication sessions in a real time “pay as you go” manner. This allows greater transparency for the user and greatly simplified administration for the service provider. The user inserts payment or access tokens in the fields used for an authentication exchange, such as the username/password fields in RADIUS. The network access and RADIUS proxy servers do not need to be programmed to handle tokens, merely processing them as passwords and usernames.

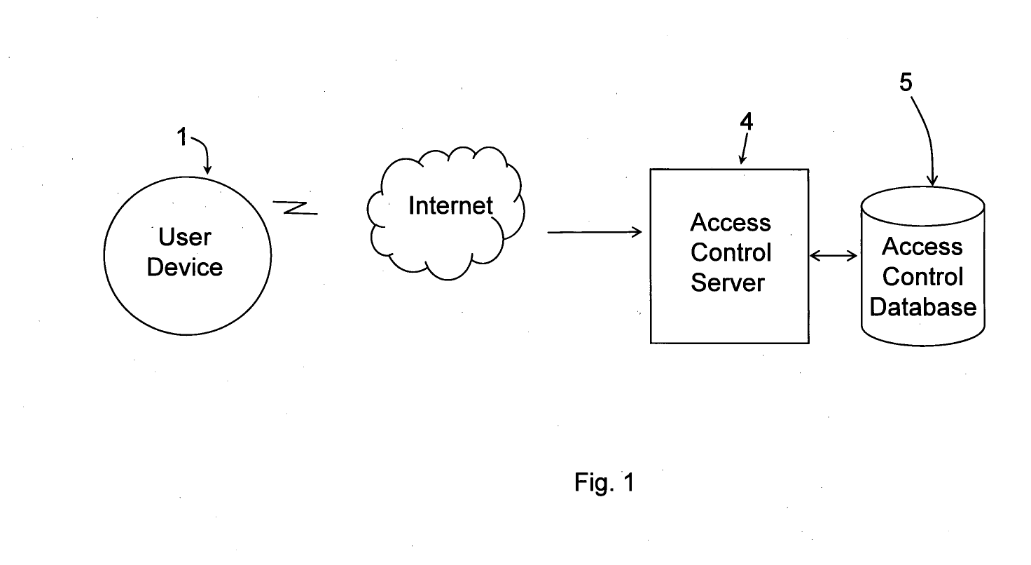

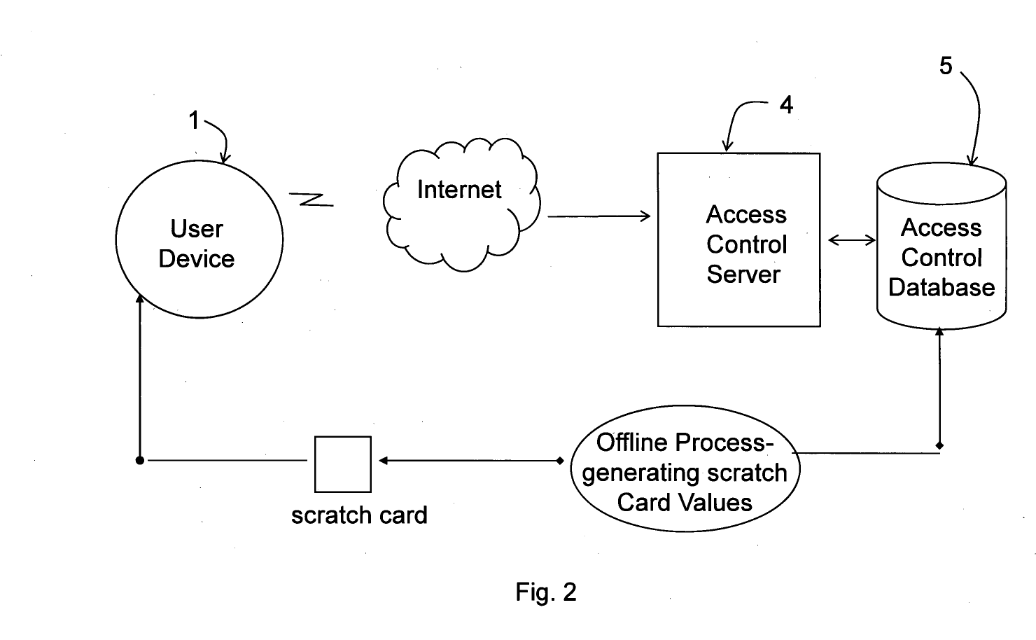

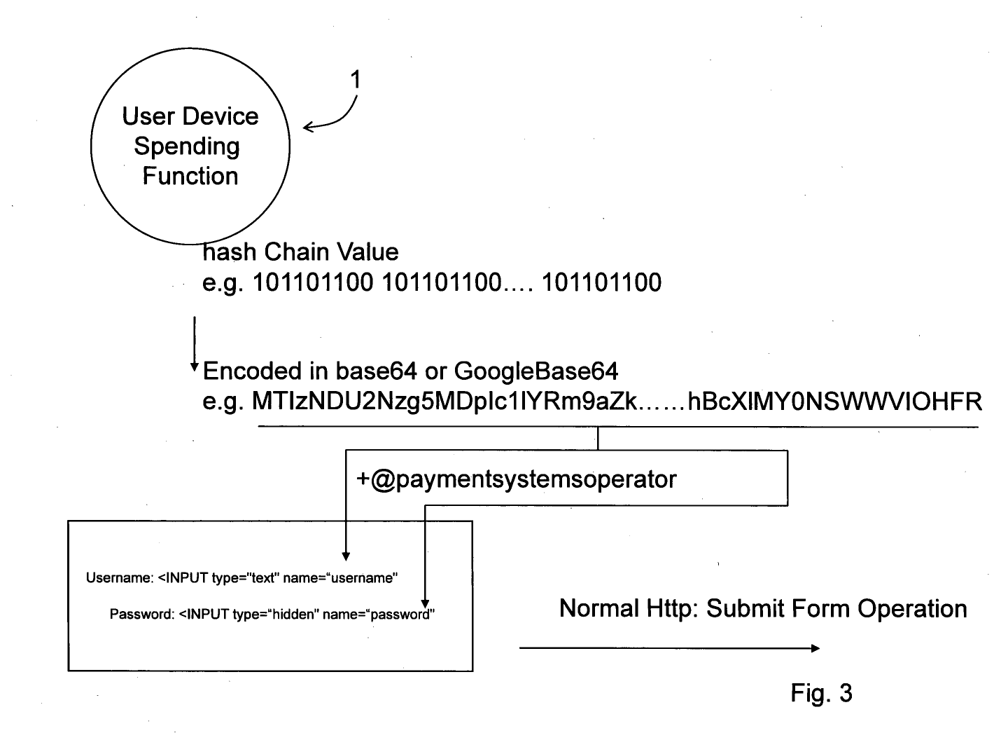

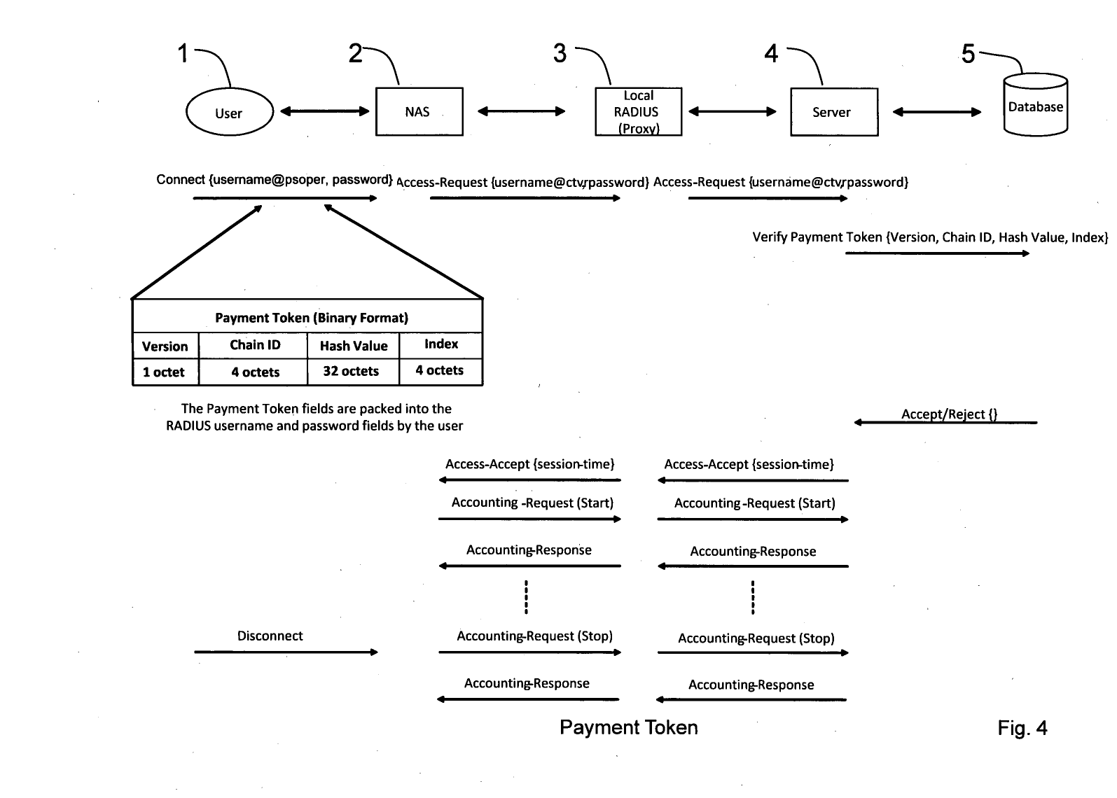

FIGS. 1 and 2 show that a user device 1 communicates via the Internet with a payment server 4 which updates an access control database 5, to purchase tokens. FIG. 3 illustrates how the user device transmits the tokens. FIG. 4 shows that the main elements involved in a communication session are the user device I such as a laptop computer, a network access server (NAS) 2, a local RADIUS proxy server 3, the real time access control server 4, and the database 5. A RADIUS server will normally accept a username:password (e.g. Alice:xdfht) and verify it against a database that is kept locally. In order to support roaming—any username that contains an “@” (e.g. Alice@T-mobile:sdfht) is taken to be a username that must be verified by some other RADIUS server against a different database of users. The first RADIUS server consequently forwards the request to whichever RADIUS server is appropriate. In this mode it is acting as a proxy-server for the server 4 that will ultimately make the check.

The user purchases access tokens in the form of a hash chain (as described below) and pays for them using a traditional macropayment mechanism such as a credit/debit card transaction over the WWW. The tokens are used in real time by inserting them in the username/password fields even though there is no permanent or necessarily continuing association with the vendor of the tokens. Also, the tokens can be transferred from one person to another—akin to a currency. Any person who has access to a token can attempt to spend it, the first attempt being successful.

### Purchase of Tokens

In more detail, referring particularly to FIG. 1 the user device I executes software that is capable of (a) purchasing hash-chain-based tokens through an internet dialog, (b) managing a local store of such tokens with potentially several distinct chains begin used up in sequence, and (c) feeding such tokens to the network in the fields of an authentication exchange.

Software on the user device 1 interacts with purchasing software of the server 4. The user device 1 software generates a hash chain consisting of an anchor value and the chain length. A version number is appended to this information to complete the package. The user device sends this completed package to the server 4, and in the same dialog exchanges information necessary to buy the chain. This information could be credit card details (name, card no, expiry date) or any other internet macropayment method (e.g. a paypal exchange). A purchase function of the server 4 will validate the macropayment and if verified, will enter the details of the new hash chain in its database. At this point, the server 4 assigns a unique chain identifier which will be returned to the user cryptographically signed by the payment systems operator (serving as a receipt) with a success indication.

The hash chain is generated by the user device in a manner as described in [Lam81]. This involves the repeated evaluation of a one-way hash function to generate a chain of values allowing many user authentications. A one-way chain or hash chain of length n is constructed by applying a hash function n times to a random value labelled xₙ. The value Xₙ is called the root value of the hash chain. A hash chain can be derived using a hash function H recursively as:

Hⁿ(y)=H(Hⁿ⁻¹(y))

H⁰(y)=xₙ

where Hⁿ(y) is the result of applying a hash function repeatedly n times to an original value y. The final hash value, or anchor, of the hash chain after applying the hash function n times is x₀=Hⁿ(xₙ). The hashes are numbered in increasing order from the chain anchor x₀, such that H(x₁)=x₀, and H(x₂)=x₁.

In an alternative approach, referring to FIG. 2 an offline process generates a random number which is sufficiently large that the statistical chances of guessing it are very low, but is not so large that users will find it burdensome to type in to a handset. We suggest a typical value of 10-12 digits with the optional inclusion of a check digit. The offline process will store the generated values in the database 5 and also print the values on a scratch card. A user purchasing a scratch card can begin a dialog to purchase tokens. It will generate the chain anchor, length and version number as before. Instead of the macropayment details (e.g. credit card), the process will now include the number found on the scratch card which has been entered into the handset by the user. The payment systems operator process will check that this value has not been entered (spent) before. If it has not, it will mark that value as having been spent and allow the transaction to proceed, returning a signed receipt.

### Network Access

Referring to FIGS. 3 and 4, to spend the tokens, software running on the user device detects that wireless internet access is available and issues a request to retrieve a web-page. In the event that the wireless internet is provided by a public wi-fi hotspot, the user receives, in response to his query, a webpage containing a form to allow the user to enter their username and password. In some cases, there are multiple web-page re-directs before this page becomes available and the software on the user device parses the webpages and navigates through to the username and password prompt. The user software will retrieve the current hash-chain from its local store and generate the next-to-be-spent value. Depending on the hashing algorithm in use this will consist of a bit-string from 128 to 256 bits in length. It will assemble this into a package with housekeeping fields such as current index and version fields. The user software will first apply a base64 (or alternatively Google base64) encoding technique to this bit string package. This converts the bit-string into a string of alphanumeric characters that will travel without being altered through the next step in the process. The user device software will then divide up the encoded bit-string into two parts and place one into the username field and the other into the password field. The part that is inserted into the username field will have a special string of the form: “@paymentsystemsoperator” appended to it in the username field before submitting the HTTP form.

The network access server (NAS) 2 receives this HTTP form, but is completely unaware that this is anything other than a normal user login request. The NAS 2 software consequently needs no modifications whatsoever for the invention. The NAS 2 communicates—through a proprietary mechanism—the username and password fields to the attached RADIUS authentication server 3.

Once again, this first RADIUS server 3 has no knowledge of the fact that this exchange is anything other than a normal login request. RADIUS servers as part of their normal operation support roaming users. When the RADIUS server 3 sees that the username ends with “@paymentsystemsoperator”, it concludes that this is a roaming user whose username and password need to be verified by another RADIUS server, namely the access control server 4. A configuration file local to the RADIUS server 3 will be used to look up the “paymentsystemsoperator” string and find the RADIUS server 4 to which the login request should be re-directed. This re-direction can take place more than once. A RADIUS “Access-Request” operation will be issued by the first RADIUS server 3 and will be re-directed through zero or more intermediate RADIUS servers before arriving at the server 4.

The access control server 4 can be implemented as a normal RADIUS server (e.g. FreeRadius) with a special purpose module used to intercept the step where the RADIUS server checks the username+password for validity. At this point, software code strips the username of its “@paymentsystemsoperator” suffix, concatenates it with the password field, and decodes it from base64 to recover the payment token package. This is then checked against the database of hash chains to check its validity. If it all checks out, the entry for that hash-chain in the database is updated and a positive reply in the form of a RADIUS “Access-Accept(Session Time)” is sent. This travels back to the originating RADIUS server and is used to switch on network access for a fixed time quantum.

In another embodiment, the user device packs the following fields into the RADIUS message fields:
Version—The version number of the software he is using
Chain ID—The unique chain identifies that it was generated by the vendor
Hash Value—The token in the hash chain that he is releasing
Index—The position of the token in the hash chain

The above are example implementations of the invention. However, it is envisaged that alternative implementations might involve paying in real time for home broadband, at an Internet Café, or for mobile phone use. Also, the authentication exchange fields in any protocol other than RADIUS may be used.

It will be appreciated that because existing authentication fields are used, the infrastructure for implementing the invention already exists and so it may be easily implemented.

The invention is not limited to the embodiments described but may be varied in construction and detail.

1-26. (canceled)

27. A method for controlling access to a communication network, the method comprising the steps of:
(a) a user device transmitting a network access request including an access token in at least one field of an authentication exchange, and
(b) an access control server determining a network access credit corresponding to the token, and allowing access by the user device to the network in real time to the extent of the credit;
wherein a network access server passes the request to an authentication server, while treating the request as a conventional login request; and
wherein the authentication server processes the access request as a conventional login request and directs it to the access control server.

28. The method as claimed in claim 27, comprising the additional steps of repeating steps (a) and (b) for incrementally adding to a single communication session.

29. The method as claimed in claim 28, wherein the credit is a time period, and steps (a) and (b) are repeated to add at least one time period to the session.

30. The method as claimed in claim 27, wherein an authentication field is a username field.

31. The method as claimed in claim 27, wherein an authentication field is a password field.

32. The method as claimed in claim 27, wherein the authentication field is under the RADIUS protocol.

33. The method as claimed in claim 27, wherein said authentication server is a proxy server.

34. The method as claimed in claim 27, wherein the access token is encrypted.

35. The method as claimed in claim 27, wherein the access token includes a hash value.

36. The method as claimed in claim 35, wherein the user device stores a chain of hash values, and releases a hash value from a hash chain as a token, and successive access tokens include successive hash values.

37. The method as claimed in claim 35, wherein the access token also includes a hash chain identifier.

38. The method as claimed in claim 34, wherein the encryption provides alphanumeric characters for the token.

39. The method as claimed in claim 34, wherein the encrypted token is split across a plurality of authentication fields.

40. The method as claimed in claim 35, wherein a token includes a flag, recognised by the authentication server, indicating that the access control server needs to process it.

41. The method as claimed in claim 40, wherein the flag is a HTTP domain name.

42. The method as claimed in claim 27, wherein the method comprises the further steps of the user device initially accessing a token-selling server which manages token issuing.

43. The method as claimed in claim 42, wherein the user device generates the tokens and updates the token-selling server.

44. The method as claimed in claim 43, wherein the user device uploads the tokens to the token-selling server, the server registers them in a database, and transmits a receipt to the user device.

45. The method as claimed in claim 42, wherein the token-selling server generates a message or ticket with the token, sends the message or ticket to the user, and the user manually inputs the token in the authentication field for network access.

46. The communication system comprising a user device and an access control server for performing the steps of a method of claim 27.

47. A computer readable medium comprising software code for performing user device steps of a method of claim 27 when executing on a user device processor.

48. The computer readable medium comprising software code for performing server steps of a method of claim 27 when executing on a server processor.
